(19) United States
(12) Patent Application Publication
(10) Pub. No.: US 2026/0002495 A1
(43) Pub. Date: Jan. 1, 2026

(54) THRUST FROM HYDROGEN FUEL CELL WASTE

(71) Applicants: Gabriel DEVAULT, Cirencester, Gloucestershire (GB); Valery MIFTAKHOV, Hollister, CA (US); Asif SADIK, Cirencester, Gloucestershire (GB); Christian BAILEY, Hollister, CA (US); Bob L. MACKEY, Hollister, CA (US); ZeroAvia Ltd, Cirencester (GB)

(72) Inventors: Gabriel DEVAULT, Cirencester (GB); Valery MIFTAKHOV, Hollister, CA (US); Asif SADIK, Cirencester (GB); Christian BAILEY, Hollister, CA (US); Bob L. MACKEY, Hollister, CA (US)

(21) Appl. No.: 18/878,463

(22) PCT Filed: Jun. 23, 2022
(86) PCT No.: PCT/US2022/073127

§ 371 Date: Dec. 23, 2024

(51) Int. Cl. F02K 5/00; F02C 3/22

(52) U.S. Cl. CPC F02K 5/00; F02C 3/22; F05D 2220/323

(57) ABSTRACT

An integrated hydrogen-electric engine including an air compressor system, a hydrogen fuel source, a fuel cell, a heat exchanger, an elongated shaft, a motor assembly and a combustion chamber including a turbine downstream of the fuel cell configured to burn or catalytically react unburned hydrogen gas in the fuel cell waste, to drive the turbine to add additional torque to the shaft. The heat exchanger is disposed in fluid communication with the hydrogen fuel source and the fuel cell. The elongated shaft is connected to the air compressor and/or a propulsor. The motor assembly is disposed in electrical communication with the fuel cell.

The present disclosure relates to integrated hydrogen fuel cell electric engine systems. The disclosure has particular utility to hydrogen fuel cell electric engines for use with transport vehicles including aircraft and will be described in connection with such utility, although other utilities are contemplated.

Exhaust emissions from transport vehicles are a significant contributor to climate change. Conventional fossil fuel powered terrestrial transport vehicles, water craft and aircraft release CO₂ emissions. Also conventional fossil fuel powered aircraft emissions include non-CO₂ effects due to nitrogen oxide (NOx), vapor trails and cloud formation triggered by the altitude at which aircraft operate. These non-CO₂ effects are believed to contribute twice as much to global warming as aircraft CO₂ and were estimated to be responsible for two thirds of aviation's climate impact.

Rechargeable battery powered terrestrial vehicles, i.e., “EVs” are slowly replacing conventional fossil fuel powered terrestrial vehicles. However, the weight of batteries and limited energy storage of batteries makes rechargeable battery powered aircraft generally impractical. Also, many consumers are reluctant to purchase a rechargeable battery powered terrestrial vehicle due to limited range capabilities and the greater time required to recharge batteries as compared to the time it takes to fill a petrol tank.

Hydrogen fuel cells offer an attractive alternative to fossil fuel burning engines. Hydrogen fuel cell tanks may be quickly filled and store significant energy, and other than the relatively small amount of unreacted hydrogen gas, the exhaust from hydrogen fuel cells comprises only water. And, while the amount of unreacted hydrogen gas exhausted by typical fuel cell is relatively small, even small increases in fuel efficiency can be significant. For example, in the case of hydrogen fuel cell powered airplane, a 1% increase in fuel efficiency could result in a 10% increase in range.

In order to overcome the aforesaid and other problems of the prior art, in accordance with the present disclosure, we burn unreacted hydrogen gas to produce combustion products which are employed to spin a turbine to add additional torque to an integrated hydrogen cell-electric engine. In one aspect of our disclosure the unreacted hydrogen gas is ignited and burned in a combustion chamber and the combusted products employed to spin a turbine mechanically connected to a common shaft of the hydrogen cell-electric engine. In another aspect of the disclosure the unreacted hydrogen gas is “ignited” by flowing over a catalyst in the combustion chamber.

In an alternative embodiment, excess air is added to the hydrogen fuel cell feed to add excess oxygen over that required for stoichiometric reaction of the oxygen and hydrogen to H₂O, to ensure that substantially all hydrogen gas fed to the fuel cell is reacted. In such embodiment, hydrogen and/or oxygen concentration sensor(s) are provided, connected to a controller configured to open a valve allowing excess air to flow from the compressor section of the engine to be mixed with the hydrogen fuel cell feed.

More particularly, in one aspect we provide an integrated hydrogen-electric engine comprising: an air compressor system; a hydrogen fuel source; a fuel cell; an elongated shaft connected to the air compressor system and/or a propulsor; a motor assembly disposed in electrical communication with the fuel cell; and a combustion chamber including a turbine downstream of the fuel cell configured to burn or catalytically react unburned hydrogen gas in an exhaust stream of the fuel cell, to drive the turbine to torque the elongated shaft.

In one aspect the motor assembly includes at least one electric motor that is disposed in coaxial alignment with the elongated shaft. Preferably the at least one electric motor is actuatable to rotate the elongated shaft.

In other aspects the turbine may be fixedly connected to the elongated shaft, or the turbine is configured to engage the elongated shaft when rotating at least as fast as the elongated shaft.

In another aspect the air compressor is configured to inject excess air into the combustion chamber. In such aspect a bypass valve preferably is configured to control an amount of excess air injected into the combustion chamber to create a stoichiometric excess of oxygen in the combustion chamber may be provided.

In yet another aspect the combustion chamber includes an over pressure valve configured to dump excess pressure to atmosphere to prevent blow back from the combustion chamber to the fuel cell.

In a further aspect, we include a flapper valve on an outlet of the fuel cell configured to prevent combustion gasses or over pressure blow back to the fuel cell.

In another aspect we include hydrogen gas and/or oxygen gas sensors located between the fuel cell and the combustion chamber, configured to measure concentration of hydrogen and/or oxygen in the exhaust stream from the fuel cell.

In a further aspect we include a controller disposed in electrical communication with at least one of the hydrogen and/or gas sensors, air compressor system, the hydrogen fuel source, the fuel cell, the heat exchanger, or the motor assembly.

In another aspect the integrated hydrogen-electric engine includes a propulsor supported on a distal end of the elongated shaft.

In a further aspect the fuel cell and the combustion chamber including the turbine are disposed concentrically about the elongated shaft.

In yet another aspect the integrated hydrogen-electric engine may be configured to power an aircraft, or to power a terrestrial vehicle or water craft.

We also provide a method for increasing efficiency of an integrated hydrogen-electric engine comprising: an air compressor system; a hydrogen fuel source; a fuel cell; an elongated shaft connected to the air compressor system and/or the propulsor; a motor assembly disposed in electrical communication with the fuel cell, comprising providing a combustion chamber including a turbine downstream of the fuel cell configured to burn or catalytically react unburned hydrogen gas in an exhaust stream of the fuel cell; feeding the exhaust stream from the fuel cell into the combustion chamber igniting or catalytically burning the hydrogen gas and directing products of combustion to spin the turbine and adding energy from the spinning turbine to the shaft.

In one aspect of the method air is injected into the exhaust stream from the fuel cell to add a stoichiometrically excess amount of oxygen to hydrogen in the exhaust stream. In such aspect we preferably provide an over pressure relief valve in the combustion chamber to dump excess pressure to atmosphere to avoid blow back to the fuel cell.

In another aspect of the method we provide a flapper valve on an outlet of the fuel cell to prevent combustion gasses or over pressure blow back to the fuel cell.

According to a first aspect of the present invention there is provided an integrated hydrogen-electric engine comprising: an air compressor system; a hydrogen fuel source; a fuel cell; an elongated shaft connected to the air compressor system and/or a propulsor; a motor assembly disposed in electrical communication with the fuel cell; and a combustion chamber including a turbine downstream of the fuel cell configured to burn or catalytically react unburned hydrogen gas in an exhaust stream of the fuel cell, to drive the turbine to torque the elongated shaft.

Preferably the motor assembly includes at least one electric motor that is disposed in coaxial alignment with the elongated shaft.

Preferably the at least one electric motor is actuatable to rotate the elongated shaft.

Preferably the turbine is fixedly connected to the elongated shaft.

Preferably the turbine is configured to engage the elongated shaft when rotating at least as fast as the elongated shaft.

Preferably the air compressor is configured to inject excess air into the combustion chamber. Preferably the integrated hydrogen-electric engine further comprise a bypass valve, preferably the bypass valve is configured to control an amount of excess air injected into the combustion chamber to create a stoichiometric excess of oxygen in the combustion chamber.

In yet another aspect the combustion chamber includes an over pressure valve configured to dump excess pressure to atmosphere to prevent blow back from the combustion chamber to the fuel cell.

Preferably the integrated hydrogen-electric engine further includes a flapper valve on an outlet of the fuel cell configured to prevent combustion gasses or over pressure blow back to the fuel cell.

Preferably the integrated hydrogen-electric engine further comprises hydrogen gas and/or oxygen gas sensors located between the fuel cell and the combustion chamber, configured to measure concentration of hydrogen and/or oxygen in the exhaust stream from the fuel cell.

Preferably the integrated hydrogen-electric engine further comprises a controller disposed in electrical communication with at least one of the hydrogen and/or gas sensors, air compressor system, the hydrogen fuel source, the fuel cell, the heat exchanger, or the motor assembly.

Preferably the integrated hydrogen-electric engine further comprises a propulsor supported on a distal end of the elongated shaft.

Preferably the fuel cell and the combustion chamber including the turbine are disposed concentrically about the elongated shaft.

Preferably the integrated hydrogen-electric engine is configured to power an aircraft

Preferably the integrated hydrogen-electric engine is configured to power a terrestrial vehicle or water craft.

According to a second aspect of the present invention there is provided a method for increasing efficiency of an integrated hydrogen-electric engine according to the first aspect of the present invention comprising feeding the exhaust stream from the fuel cell into the combustion chamber igniting or catalytically burning the hydrogen gas and directing products of combustion to spin the turbine and adding energy from the spinning turbine to the shaft.

Preferably air is injected into the exhaust stream from the fuel cell to add a stoichiometrically excess amount of oxygen to hydrogen in the exhaust stream. Preferably an over pressure relief valve is provided in the combustion chamber to dump excess pressure to atmosphere to avoid blow back to the fuel cell.

Preferably a flapper valve on an outlet of the fuel cell to prevent combustion gasses or over pressure blow back to the fuel cell.

According to a third aspect of the present invention there is provided a method for increasing efficiency of an integrated hydrogen-electric engine comprising: an air compressor system; a hydrogen fuel source; a fuel cell; an elongated shaft connected to the air compressor system and/or the propulsor; a motor assembly disposed in electrical communication with the fuel cell, comprising providing a combustion chamber including a turbine downstream of the fuel cell configured to burn or catalytically react unburned hydrogen gas in an exhaust stream of the fuel; feeding the exhaust stream from the fuel cell into the combustion chamber igniting or catalytically burning the hydrogen gas and directing products of combustion to spin the turbine and adding energy from the spinning turbine to the shaft.

Preferably air is injected into the exhaust stream from the fuel cell to add a stoichiometrically excess amount of oxygen to hydrogen in the exhaust stream. Preferably an over pressure relief valve is provided in the combustion chamber to dump excess pressure to atmosphere to avoid blow back to the fuel cell.

Preferably a flapper valve on an outlet of the fuel cell to prevent combustion gasses or over pressure blow back to the fuel cell.

Further features and advantages of the subject disclosure will be seen from the following detailed description, taken in conjunction with the accompanying drawings, wherein:

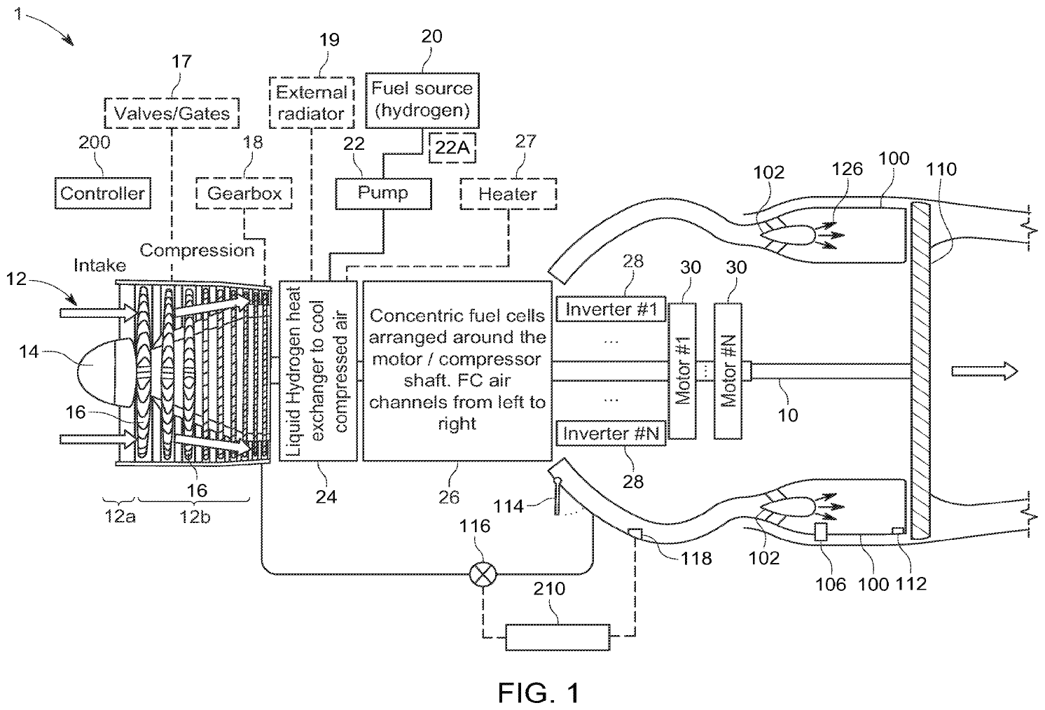

FIG. 1 is schematic view of an integrated hydrogen fuel cell-electric engine system in accordance with the principles of this disclose;

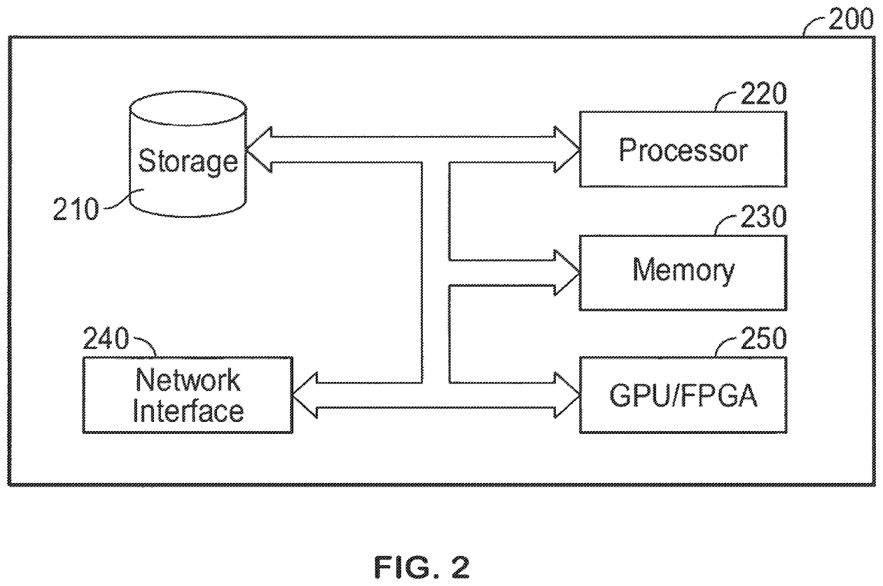

FIG. 2 is block diagram of a controller configured for use with the integrated hydrogen fuel cell-electric engine system of FIG. 1; and

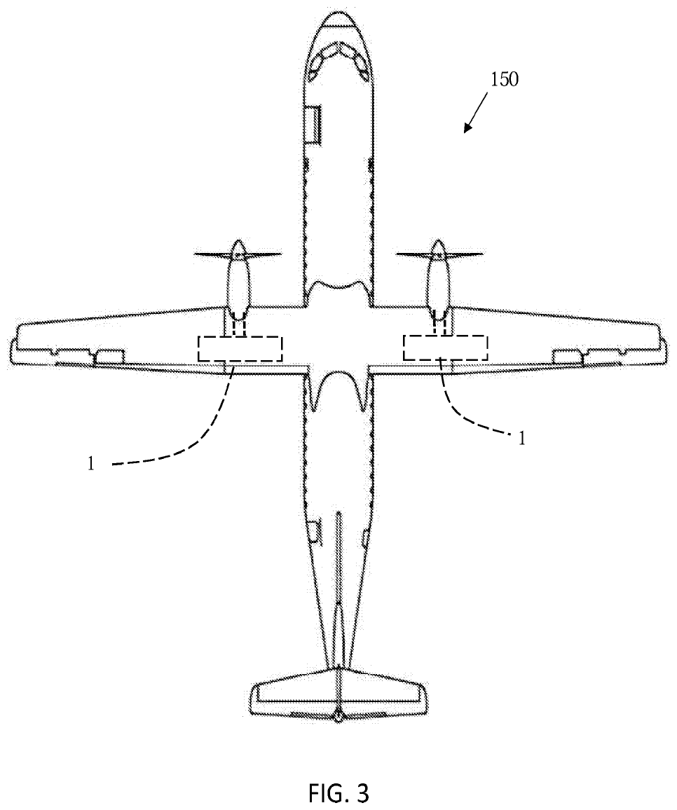

FIG. 3 is a schematic depiction of an aircraft including integrated hydrogen fuel cell-electric engines in accordance with the present disclosure.

FIGS. 1 and 2 illustrate integrated hydrogen-electric engine system 1 that can be utilized, for example, in a turboprop or turbofan system, to provide a streamlined, light weight, power dense and efficient system. In general, integrated hydrogen-electric engine system 1 includes an elongated shaft 10 that defines a longitudinal axis “L” and extends through the entire powertrain of integrated hydrogen-electric engine system 1 to function as a common shaft for the various components of the powertrain. Elongated shaft 10 supports propulsor 14 (e.g., a fan or propeller) and a multi-stage air compressor system 12, a pump 22 in fluid communication with a fuel source 20 (e.g., liquid hydrogen), a heat exchanger 24 in fluid communication with air compressor system 12, a fuel cell 26 (e.g., a fuel cell stack) in fluid communication with heat exchanger 24, and a motor assembly 30 disposed in electrical communication with inverters 28. Alternatively, one or more of the components e.g., pump 22A, as shown in phantom, may be electrically driven by output from the fuel cell 26.

Air compressor system 12 includes an air inlet portion 12a at a front end thereof and a compressor portion 12b that is disposed proximally of air inlet portion 12a for uninterrupted, axial delivery of air flow in the proximal direction. Compressor portion 12b supports a plurality of longitudinally spaced-apart rotatable bladed compressor wheels 16 (e.g., multi-stage) that rotate in response to rotation of elongated shaft 10 for compressing air received through air inlet portion 12a for pushing the compressed air to a fuel cell 26 for conversion to electrical energy. As can be appreciated, the number of compressor wheels/stages 16 and/or diameter, longitudinal spacing, and/or configuration thereof can be modified as desired to change the amount of air supply, and the higher the power, the bigger the propulsor 14. These compressor wheels 16 can be implemented as axial or centrifugal compressor stages. Further, the compressor can have one or more bypass valves and/or wastegates 17 to regulate the pressure and flow of the air that enters the downstream fuel cell, as well as to manage the cold air supply to any auxiliary heat exchangers in the system.

Propulsor 14 optionally can be mechanically coupled to elongated shaft 10 via a gearbox 18 to change (increase and/or decrease) propulsor rotations per minute (RPM).

Integrated hydrogen-electric engine system 1 further includes a gas management system such as a heat exchanger 24 disposed concentrically about elongated shaft 10 and configured to control thermal and/or humidity characteristics of the compressed air from air compressor system 12 for conditioning the compressed air before entering fuel cell 26. Integrated hydrogen-electric engine system 1 further also includes a fuel source 20 of cryogenic fuel (e.g., liquid hydrogen—LH2, or cold hydrogen gas) that is operatively coupled to heat exchanger 24 via a pump 22 configured to pump the fuel from fuel source 20 to heat exchanger 24 for conditioning compressed air. In particular, the fuel, while in the heat exchanger 24, becomes gasified because of heating (e.g., liquid hydrogen converts to gas) which removes heat from the system. The hydrogen gas is then heated in the heat exchanger 24 to a working temperature of the fuel cell 26, which results in a control of flow through the heat exchanger 24. In embodiments, an electric heater 27 can be coupled to or included with heat exchanger 24 to increase heat as necessary, for instance, when running under a low power regime or under cold ambient conditions. Additionally, and/or alternatively, one or more of fuel cells 26, inverters 28, and motor assembly 30 can be coupled to heat exchanger 24 for looping in the cooling/heating loops in the respective components as necessary. Such heating/cooling control can be managed, for instance, via controller 200 of integrated hydrogen-electric engine system 1. In embodiments, fuel source 20 can be disposed in fluid communication with one or more of fuel cells 26, inverters 28, motor assembly 30, or any other suitable component to facilitate cooling of such components.

Pump 22 also can be coaxially supported on elongated shaft 10 for actuation thereof in response to rotation of elongated shaft 10. Heat exchanger 24 is configured to cool the compressed air received from air compressor system 12 with the assistance of the pumped cryogenic fuel.

The integrated hydrogen-electric engine system 1 further includes an energy core in the form of a fuel cell 26, which may be circular, and is also coaxially supported around elongated shaft 10 (e.g., concentric) such that air channels of fuel cell 26 may be oriented in parallel relation with elongated shaft 10 (e.g., horizontally or left-to-right). Fuel cell 26 may be in the form of a proton-exchange membrane fuel cell (PEMFC). The fuel cells of the fuel cell 26 are configured to convert chemical energy liberated during the electrochemical reaction of hydrogen and oxygen to electrical energy. Depleted air and water vapor are exhausted from fuel cell 26. The electrical energy generated from fuel cell 26 is then transmitted to inverters 28 and then motor assembly 30, which are also coaxially/concentrically supported around elongated shaft 10. In aspects, integrated hydrogen-electric engine system 1 may include any number of external radiators 19 for facilitating air flow and adding, for instance, additional cooling. Notably, fuel cell 26 can include liquid cooled and/or air cooled cell types that so that cooling may be performed by external radiators or other devices.

One or more inverters 28 is configured to convert the direct current to alternating current for actuating one or more motors 30 in electrical communication with the inverters 28. The motor assembly 30 is configured to drive (e.g., rotate) the elongated shaft 10 in response to the electrical energy received from fuel cell 26 for operating the components on the elongated shaft 10 as elongated shaft 10 rotates.

In aspects, one or more of the inverters 28 may be disposed between motors 30 (e.g., a pair of motors) to form a motor subassembly, although any suitable arrangement of motors 30 and inverters 28 may be provided. The motor assembly 30 can include any number of motor subassemblies supported on elongated shaft 10 for redundancy and/or safety. Motor assembly 30 can include any number of fuel cells 26 configured to match the power of the motors 30 and the inverters 28 of the subassemblies. In this regard, for example, during service, the fuel cells 26 can be swapped in/out. Each fuel cell module 26 can provide any power, such as 400 kW or any other suitable amount of power, such that when stacked together (e.g., 4 or 5 modules), total power can be about 2 Megawatts on the elongated shaft 10. In embodiments, motors 30 and inverters 28 can be coupled together and positioned to share the same thermal interface so a motor casing of the motors 30 is also an inverter heat sink so only a single cooling loop goes through motor assembly 30 for cooling the inverters 29 and the motors 30 at the same time. This reduces the number of cooling loops and therefore the complexity of the system.

Up to this point, the integrated hydrogen cell-electric engine is essentially identical to the integrated hydrogen fuel cell-electric engine described in our co-pending U.S. application Ser. No. 16/950,735, filed Nov. 17, 2020, the contents of which are incorporated herein by reference. In accordance with the present disclosure, we provide a combustion chamber or “after burner” 100 downstream of the fuel cell 26 to burn any unreacted hydrogen gas in the fuel cell exhaust stream, to spin a turbine 110 downstream of the fuel cell for added thrust. The exhaust stream from the fuel cell 26, including oxygen depleted air, water and unreacted hydrogen is flowed to the combustion chamber 100 where it is mixed with additional fresh air as will be described below, injected through an injector 102 into combustion chamber 100, and the hydrogen gas present in the exhaust stream is ignited, as necessary, by an igniter 106. Ignition of the hydrogen gas in the exhaust causes expansion of the gas stream, and the expanded gas stream is directed to drive a turbine 110 on shaft 10. Turbine 110 may be rigidly fixed to shaft 10, or fixed to shaft 10 through a slip clutch configured to engage the shaft only when the turbine 110 is spinning faster than the shaft 10, so as to not add drag on the integrated hydrogen fuel cell electric engine. In order to protect the fuel cell 26 from excess pressure or blow back from combustion chamber 100, an over pressure relief valve 112 preferably is provided between ignitors 106 and turbine 110 to dump excess pressure to atmosphere. Also, flapper valves 114 may be provided on the outlet of the fuel cell 26 to prevent combustion gasses or over pressure from blowing back into the fuel cell 26.

Alternatively, as shown in phantom in FIG. 1, in place of igniter 106, the exhaust may be flowed over or through a catalyst bed 126 such as, e.g., palladium, iridium, nickel, platinum, rhodium, or ruthenium in the combustion chamber 100.

Referring again to FIG. 1, the after burner 100 also may include a hydrogen and/or oxygen concentration sensor 118 connected to controller 210 configured to receive information regarding hydrogen and/or oxygen concentration in the exhaust, to open or close a bypass air valve 116 to inject additional air (oxygen) into the hydrogen fuel cell exhaust being fed to the after burner 100 to ensure that substantially all of the hydrogen gas in the exhaust is reacted.

FIG. 3 illustrates an aircraft 150 including integrated fuel cell-electric engine systems 1 in accordance with the present disclosure.

Various changes may be made in the above disclosure without departing from the spirit and scope thereof. For example, the integrated hydrogen fuel cell-electric engine system 1 of the present disclosure may be incorporated into a terrestrial vehicle or water craft. Yet other changes are possible.

1. An integrated hydrogen-electric engine comprising:
an air compressor system;
a hydrogen fuel source;
a fuel cell;
an elongated shaft connected to the air compressor system and/or a propulsor;
a motor assembly disposed in electrical communication with the fuel cell; and
a combustion chamber including a turbine downstream of the fuel cell configured to burn or catalytically react unburned hydrogen gas in an exhaust stream of the fuel cell, to drive the turbine to torque the elongated shaft, wherein the turbine is configured to engage the elongated shaft when rotating at least as fast as the elongated shaft.

2. The integrated hydrogen-electric engine of claim 1, wherein the motor assembly includes at least one electric motor that is disposed in coaxial alignment with the elongated shaft.

3. The integrated hydrogen-electric engine of claim 2, wherein the at least one electric motor is actuatable to rotate the elongated shaft.

4. The integrated hydrogen-electric engine of claim 1, wherein the turbine is fixedly connected to the elongated shaft.

5. The integrated hydrogen-electric engine of claim 1, wherein the air compressor is configured to inject excess air into the combustion chamber.

6. The integrated hydrogen-electric engine of claim 5, further including a bypass valve configured to control an amount of excess air injected into the combustion chamber to create a stoichiometric excess of oxygen in the combustion chamber.

7. The integrated hydrogen-electric engine of claim 1, wherein the combustion chamber includes an over pressure valve configured to dump excess pressure to atmosphere to prevent blow back from the combustion chamber to the fuel cell.

8. The integrated hydrogen-electric engine of claim 1, further including a flapper valve on an outlet of the fuel cell configured to prevent combustion gasses or over pressure blow back to the fuel cell.

9. An integrated hydrogen-electric engine comprising:
an air compressor system;
a hydrogen fuel source;
a fuel cell;
an elongated shaft connected to the air compressor system and/or a propulsor;
a motor assembly disposed in electrical communication with the fuel cell; and
a combustion chamber including a turbine downstream of the fuel cell configured to burn or catalytically react unburned hydrogen gas in an exhaust stream of the fuel cell, to drive the turbine to torque the elongated shaft, wherein the turbine is configured to engage the elongated shaft when rotating at least as fast as the elongated shaft, and
further comprising hydrogen gas and/or oxygen gas sensors located between the fuel cell and the combustion chamber, configured to measure concentration of hydrogen and/or oxygen in the exhaust stream from the fuel cell.

10. The integrated hydrogen-electric engine of claim 9, further comprising a controller disposed in electrical communication with at least one of the hydrogen and/or gas sensors, the air compressor system, the hydrogen fuel source, the fuel cell, the heat exchanger, or the motor assembly.

11. The integrated hydrogen-electric engine of claim 1, further comprising a propulsor supported on a distal end of the elongated shaft.

12. The integrated hydrogen-electric engine of claim 1, wherein the fuel cell and the combustion chamber including the turbine are disposed concentrically about the elongated shaft.

13. The integrated hydrogen-electric engine of claim 1, configured to power an aircraft.

14. The integrated hydrogen-electric engine of claim 1, configured to power a terrestrial vehicle or a water craft.

15. A method for increasing efficiency of an integrated hydrogen-electric engine comprising:
an air compressor system;
a hydrogen fuel source;
a fuel cell;
an elongated shaft connected to the air compressor system and/or a propulsor;
a motor assembly disposed in electrical communication with the fuel cell, comprising providing a combustion chamber including a turbine downstream of the fuel cell configured to burn or catalytically react unburned hydrogen gas in an exhaust stream of the fuel cell;
feeding the exhaust stream from the fuel cell into the combustion chamber, igniting or catalytically burning the hydrogen gas, and directing products of combustion to spin the turbine;
adding energy from the spinning turbine to the shaft; and
including the step of providing an over pressure relief valve in the combustion chamber to dump excess pressure to atmosphere to avoid blow back to the fuel cell.

16. A method for increasing efficiency of an integrated hydrogen-electric engine, comprising the steps of:
an air compressor system;
a hydrogen fuel source;
a fuel cell;
an elongated shaft connected to the air compressor system and/or a propulsor;
a motor assembly disposed in electrical communication with the fuel cell; and
a combustion chamber including a turbine downstream of the fuel cell configured to burn or catalytically react unburned hydrogen gas in an exhaust stream of the fuel cell, to drive the turbine to torque the elongated shaft, wherein the turbine is configured to engage the elongated shaft when rotating at least as fast as the elongated shaft
feeding the exhaust stream from the fuel cell into the combustion chamber, igniting or catalytically burning the hydrogen gas, and directing products of combustion to spin the turbine, and
adding energy from the spinning turbine to the shaft.

17. The method of claim 15, wherein air is injected into the exhaust stream from the fuel cell to add a stoichiometrically excess amount of oxygen to hydrogen in the exhaust stream.

18. The method of claim 15, including the step of providing a flapper valve on an outlet of the fuel cell to prevent combustion gasses or over pressure blow back to the fuel cell.

19-20. (canceled)
